(19) United States
(12) Patent Application Publication
(10) Pub. No.: US 2017/0057286 A1
(43) Pub. Date: Mar. 2, 2017

(54) FLAT RESISTANT VEHICULAR TIRE

(71) Applicants: RONALD D. SHAW, COSTA MESA, CA (US); DAVID MITCHELL BYRD, SAN CLEMENTE, CA (US)

(72) Inventors: RONALD D. SHAW, COSTA MESA, CA (US); DAVID MITCHELL BYRD, SAN CLEMENTE, CA (US)

(21) Appl. No.: 14/839,389

(22) Filed: Aug. 28, 2015

(51) Int. Cl. B60C 5/00; B60C 23/04; B60C 29/04; B60C 5/04

(52) U.S. Cl. CPC B60C 5/002; B60C 5/04; B60C 23/04; B60C 29/04

(57) ABSTRACT

An insert specifically adapted for use with an off-road tire, such as an off-road tire of a motocross motorcycle, or an off-road bicycle. The insert includes an inflatable tube and a foam element which generally conforms to the contours of the off-road tire to provide support to the tire when the tube is inflated. The ability to deflate the insert facilitates installation of the insert between the wheel rim and off-road tire. When inflated, the insert occupies the space between the wheel rim and tire to support a load during use of the wheel.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure generally relates to an inflatable insert for a vehicle wheel, and more specifically to a flat-resistant inflatable insert having an inflatable tube and a foam element cooperating with the inflatable tube, with the foam element being complimentary in shape to a tire and rim of a vehicle wheel.

2. Description of the Related Art

It is well known that conventional vehicle tire systems utilize a compressed gas to allow for selective pressurization of the corresponding tire. Such conventional tire systems can be tubeless or include an inner tube which are accessed via a conventional valve stem.

However, in off-road terrain applications typically encountered with riding a motorcycle, bicycle, or all-terrain vehicles, conventional tire systems are susceptible to pinch flats as the result of objects such as cactus needles, sharp sticks, nails, or the like that one might encounter on off-road terrain. Accordingly, some off-road anti-flat tire systems, such as a mousse pack, e.g., the Michelin Bib Mousse™, have been developed as a substitute for the traditional conventional tire systems. The Michelin Bib Mousse™ generally includes a foam insert for off-road tires, which is typically made from a multi-cellular butyl material. Michelin Bib Mousse™ inserts are typically designed for off-road use at speeds up to 80 mph. The installation of a Michelin Bib Mousse™ on a wheel may provide support comparable to a tire pressure of approximately 13 psi (0.9 bar). For additional information regarding the Michelin Bib Mousse™, please refer to http://motorcycle.michelinman.com/advice/buying-guide/michelin-bib-mouse-the-michelin-off-road-solution-to-punctures, the contents of which are expressly incorporated herein by reference.

Although mousse packs provide a suitable replacement of the conventional inner tubes, mousse packs also suffer from some deficiencies. One significant deficiency associated with mousse packs is that they tend to break down over time, e.g., lose their resiliency, which results in users feeling as though the tire has lost pressure. Furthermore, since conventional mouse packs are non-inflatable, the user is not able to re-inflate the tire. In particular, losing tire pressure significant affects the handling of the off-road vehicle and can cause damages to the wheel rim and vehicle. Thus, the only recourse available to the user may be to remove the old mousse pack and insert a new mousse pack. However, in some situations, the user may not have access to tools required to swap out the mousse pack. For instance, the user may be at an off-road site and not have the necessary tools to install the mousse pack.

Another deficiency commonly associated with mousse packs is that the tire pressure in conventional mousse packs cannot be adjusted and configured to match a specified environmental condition. Therefore, users may be limited to certain driving terrain, which may otherwise be prevented if the user is able to adjust the tire pressure accordingly to their desired specification.

In view of the foregoing, there is a need in the art for puncture resistant, inflatable off road tire system adapted to allow a user to easily install the system between a wheel rim and an off-road tire to mitigate deflation of the tire during use. Various aspects of the present disclosure address these particular needs, as will be discussed in more detail below.

### BRIEF SUMMARY OF THE INVENTION

There is provided an insert specifically adapted for use with an off-road tire, such as an off-road tire of a motorcycle, an off-road bicycle, or other off-road vehicles. The insert includes an inflatable tube and a foam element which generally conforms to the internal contours of the off-road tire and/or wheel rim to provide support to the tire when the tube is inflated. The ability to deflate the insert facilitates installation of the insert between the wheel rim and off-road tire. When inflated, the insert occupies the space between the wheel rim and tire to support a load during use of the wheel. The ability to inflate the tire further allows for selective adjustment of the tire pressure to accommodate different riding conditions.

According to one embodiment, there is provided an inflatable insert for use with a tire and a wheel rim. The inflatable insert includes an inflatable tube having an outer surface and an inner surface, with the inflatable tube being configured to circumvent an outer diameter of the wheel rim. The inflatable tube is selectively transitional between an inflated configuration and a deflated configuration, wherein fluid is inserted into the inflatable tube to transition the inflatable tube from the deflated configuration toward the inflated configuration. A foam element cooperates with the inflatable tube and includes an outer surface complimentary to an inner surface of the tire. The foam element is configured to substantially occupy a space between the outer surface of the inflatable tube and the inner surface of the tire when the inflatable insert is positioned between the tire and the wheel rim.

The inflatable tube may be lined with a puncture resistant material. The puncture resistant material may be a Kevlar™ material. The puncture resistant material may be positioned adjacent the outer surface of the inflatable tube.

The inflatable tube may be configured such that a stiffness of the inflatable tube in the inflated configuration is greater than a stiffness of the foam element.

The foam element may be lined with a polymer material to facilitate installation thereof between the wheel rim and the tire.

The inner surface of the inflatable tube may define a fluid chamber. The inflatable insert may further comprise a valve element coupled to the inflatable tube and in fluid communication with the fluid chamber. The valve element may comprise a tire pressure monitor sensor and display gauge.

A pressure within the inflatable tube may increase as the inflatable tube is transitioned from the deflated configuration toward the inflated configuration. A volume of the inflatable tube may increase when the inflatable tube is transitioned from the deflated configuration toward the inflated configuration.

The foam element may impart a radially outward force upon the tire when the insert is positioned between the wheel rim and the tire, and when the inflatable tube is transitioned from the deflated configuration to the inflated configuration.

The foam element may partially encapsulate the inflatable tube. The foam element may include a convex surface extending between a pair of sidewalls. The foam element may include a concave surface defining a cavity, with the inflatable insert being at least partially received within the cavity.

According to another embodiment, there is provided an insert for use with a wheel rim and an off-road tire. The insert includes a non-inflatable, compressible element having an outer surface that is of an external configuration complimentary to an inner surface of the off-road tire. An inflatable element cooperates with the non-inflatable, compressible element and is configured to be selectively transitional between a deflated configuration and an inflated configuration, with the volume of the inflatable element increasing as the inflatable element is transitioned from the deflated configuration toward the inflated configuration. The non-inflatable, compressible element and the inflatable element are sized and configured to substantially occupy a space between the wheel rim and the off-road tire when the insert is placed between the wheel rim and the off-road tire, and the inflatable element is transitioned from the deflated configuration toward the inflated configuration.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a elevational view of one embodiment of a wheel having an insert disposed between a wheel rim and an off-road tire;

FIG. 2 illustrates a partial cross-sectional view taken along line 2-2 of FIG. 1 illustrating the insert located between the wheel rim and the tire and in an inflated configuration; and

FIG. 3 is a partial cross-sectional, perspective view of the insert and tire.

Common reference numerals are used throughout the drawings and the detailed description to indicate the same elements.

### DETAILED DESCRIPTION

The detailed description set forth below in connection with the appended drawings is intended as a description of the presently preferred embodiment of an puncture resistant, inflatable insert for an off-road wheel of a motorcycle, bicycle, or other off-road vehicles, and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Referring now to the drawings, wherein the showings are for purposes of illustrating a preferred embodiment of the present invention only, and not for the purposes of limiting the same, there is depicted an off-road wheel 10 having a puncture-resistant, inflatable insert 12 positioned between a wheel rim 14 and a tire 16. The insert 12 includes an inflatable tube 18 and a foam element 20. The inflatable tube 18 is capable of being deflated to facilitate insertion of the insert 12 between the wheel rim 14 and the tire 16, while the foam element 20 protects the inflatable tube 18 from inadvertent punctures. Once inserted, the inflatable tube 18 can be inflated to a prescribed tire pressure. In this respect, the insert 12 combines the desirable features of a conventional pneumatic tire systems (e.g., the ease of installation and selective pressure adjustment), and a Michelin Bib Mousse™ (e.g., lack of puncturing), without suffering from the same deficiencies, such as a high risk of puncturing in the case of the conventional pneumatic systems, or a lack of inflation ability in the case of the conventional mousse pack.

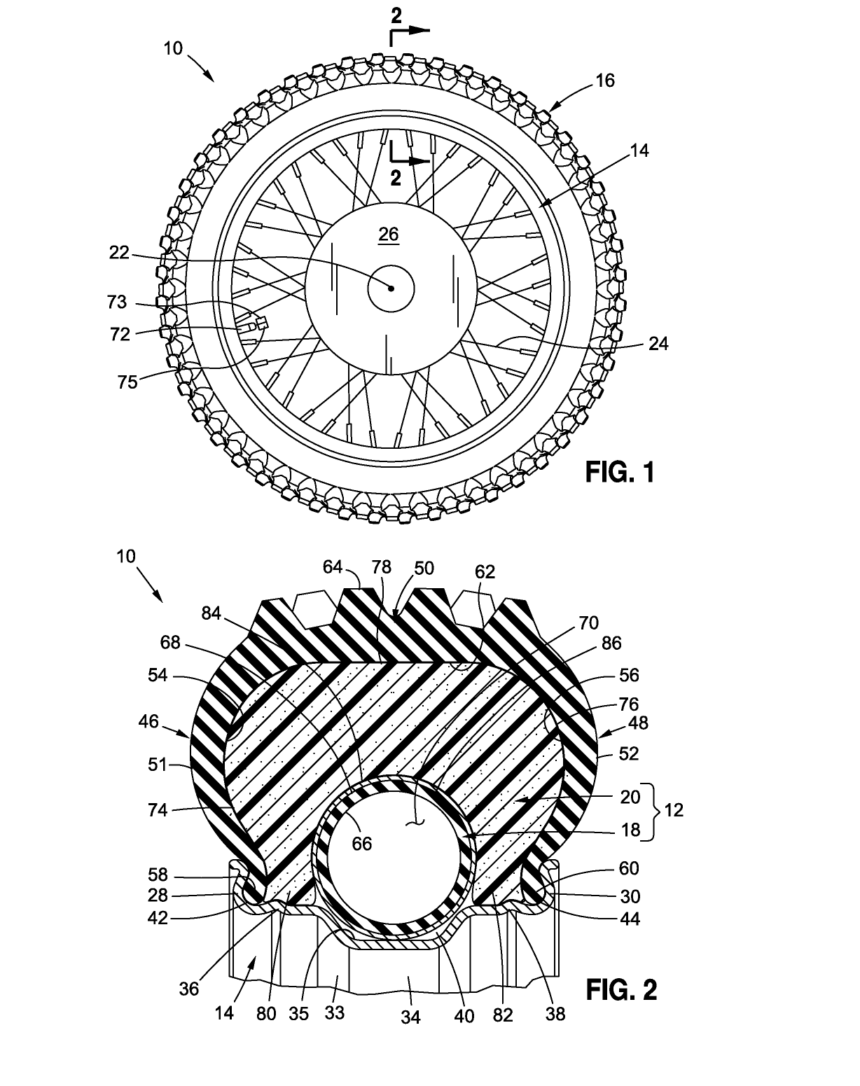

Referring now specifically to FIG. 1, the wheel 10 is disposed about a central rotation axis 22, with the wheel rim 14 and tire 16 being concentrically positioned about the central rotation axis 22. One or more spokes 24 may extend radially between the wheel rim 14 and a central wheel hub 26 to provide support to the wheel rim 14.

Referring now to FIG. 2, there is depicted a cross sectional view of the wheel 10 taken along line 2-2 in FIG. 1. The cross section depicted in FIG. 2 is taken within a plane parallel to, and including, the rotation axis 22. As shown in FIG. 2, the wheel rim 14 includes a first sidewall 28, a second sidewall 30, and a primary wall 32 extending between the first and second sidewalls 28, 30, with the primary wall 32 including an inner surface 33 and an opposing outer surface 35. According to one embodiment, the primary wall 32 includes a radially inward central region 34 located between a pair of radially outward lateral regions 36, 38, wherein the central region 34 and lateral regions 36, 38 collectively define a central channel 40 extending along an outer periphery of the wheel rim 14, with the central channel 40 being positioned about the central rotation axis 22. The wheel rim 14 further includes a pair of lateral channels 42, 44 adjacent the base of a respective sidewall 28, 30, in proximity to the junction of the respective sidewall 28, 30 and the adjacent lateral region 36, 38 of the primary wall 32. Each lateral channel 42, 44 is disposed about the rotation axis 22.

The tire 16 includes a pair of tire sidewalls 46, 48 and a tire end wall 50 extending between the pair of tire sidewalls 46, 48. Each tire sidewall 46, 48 includes an outer surface 51, 52 and an opposing inner surface 54, 56. The sidewalls 46, 48 extend away from the tire end wall 50 and terminate in respective beads 58, 60 adapted to be received within respective ones of the pair of lateral channels 42, 44 to interconnect the tire 16 to the wheel rim 14. The tire end wall 50 also includes an inner surface 62 and an outer surface 64, with the outer surface 64 preferably having traction or gripping elements formed therein, with such traction or gripping elements being specifically adapted for off-road use. The tire 16 may be formed of rubber or other suitable materials known by those skilled in the art.

The inflatable tube 18 includes an inner surface 66 and an opposing outer surface 68, with the inner surface 66 defining an internal fluid chamber 70. The inflatable tube 18 is configured to circumnavigate the wheel rim 14, with the inflatable tube 18 being disposed about the rotation axis 22. In other words, the inflatable tube 18 extends around an outer diameter of the wheel rim 14. In the embodiment depicted in FIG. 2, the inflatable tube 18 extends around the outer diameter of the wheel rim 14 at the central region 34 of the wheel rim 14. The internal fluid chamber 70 may be in fluid communication with a valve 72, which allows for selective inflation/deflation of the tube 18. The valve 72 may include a conventional valve stem which is capable of extending through the wheel rim 14 when the tube 18 is installed on the wheel rim 14. The valve is further adapted to be engaged with an air pump, or other pressurized fluid source for inflating the tube 18. In this respect, it is understood that the inflatable tube 18 may be filled with air, nitrogen, carbon dioxide, or other fluids known in the art. According to one embodiment, the valve 72 may be fluidly coupled to a pressure sensor 73 and/or display gauge 75 to monitor and display the pressure within the tube 16.

The foam element 20 cooperates with the inflatable tube 18 and is designed to at least partially surround the inflatable tube 18 to mitigate the likelihood of puncturing of the inflatable tube 18. Furthermore, when the insert 12 is inserted between the wheel rim 14 and the tire 16, and the inflatable tube 18 is inflated, the foam element 20 is configured to be engage with the tire 16 to place the tire 16 in tension.

The foam element 20 is configured to be disposed about the rotation axis 22 when the insert 12 is inserted within the wheel 10. The foam element 20 includes a pair of side surfaces 74, 76 and an end surface 78 extending between the pair of side surfaces 74, 76. The side surfaces 74, 76 of the foam element 20 are specifically configured and adapted to be complimentary in shape to the corresponding inner surfaces 54, 56 of the tire 16. Likewise, the end surface 78 is configured to be complimentary in shape to the inner surface 62 of the tire 16.

The foam element 20 further includes a pair of opposed lateral arms 80, 82 disposed on opposed sides of a central channel 84, with the central channel 84 being formed by a concave surface located between the opposed arms 80, 82 in the perspective shown in FIG. 2. The channel 84 is sized and configured to receive the inflatable tube 16 when the inflatable tube 16 is in an inflated configuration. According to one embodiment, the foam element 20 may be molded around the inflatable tube 18 when the tube 18 is in an inflated configuration, such that the tube 18 and foam element 20 form a single unit. It is also contemplated that if the foam element 20 is formed separate from the tube 18, an adhesive may be used to couple the foam element 20 to the inflatable tube 18. In other embodiments, an adhesive may not be used, and instead, the relative positioning of the foam element 20 and inflatable tube 18 may be maintained by the complimentary configuration of the foam channel 84 and the inflatable tube 16.

According to one embodiment, the foam element 20 is a non-inflatable component formed from a foam material having suitable strength to support the weight of a rider, along with a motorcycle, bicycle, car, all-terrain vehicle (ATV) or other off-road vehicles. In one implementation, the foam element 20 is formed from a resilient material, such as multi-cellular butyl material, similar to the Michelin Bib Mousse™. Of course, other materials known in the art may also be used without departing from the spirit and scope of the present disclosure.

It is contemplated that in certain embodiments, the insert 10 includes a puncture resistant material 86 to further mitigate puncturing of inflatable tube 18. Although the foam element 20 isolates the inflatable tube 18 from being punctured from many smaller items, such as small needles, rocks, pins, nails, etc., other larger items may be capable of extending to the inflatable tube 16, and thus, the puncture resistant material 86 is adapted to provide additional protection against such larger items. The puncture resistant material 86 may include Kevlar™, a woven material, or other similar materials known by those skilled in the art. In the exemplary embodiment, the puncture resistant material 86 extends completely around the outer surface 68 of the inflatable tube 18.

With the basic structural features of the insert 12 described above, an exemplary description of use of the insert 12 is provided herein below. Prior to installation of the insert 12 within a wheel 10, a user verifies that the tube 18 is deflated. By deflating the tube 18, the tube 18 assumes a smaller configuration, and thus, the overall insert 12 is more easily manipulatable by a user to fit the insert 12 between the wheel rim 14 and the tire 16.

With the tube 18 deflated, the user works the insert 12 between the wheel rim 14 and the tire 16. Since the tube 18 is deflated, the overall size of the insert 12 is smaller than the space created by the tire 16 and the wheel rim 14, which facilitates installation of the insert 12. The outer surfaces 74, 76, 78 of the foam element 20 may be coated with a polymer or similar agent which allows the foam element 20 to be more easily advanced into the wheel 10. In this regard, the polymer or agent may reduce the friction, at least during installation, between the foam element 20 and the tire 16.

When the entire insert 12 is worked into the space between the wheel rim 14 and the tire 16, the user may inflate the tube 18 by connecting the valve 72 to a pressurized fluid source. When the tube 16 is inflated, pressurized fluid is disposed into the fluid chamber 70, which causes the volume of the tube 18 to increase, and the pressure within the chamber 70 to increase. According to one embodiment, when the tube 18 is inflated, the stiffness of the tube 18 is greater than the stiffness of the foam element 20.

Inflation of the tube 18 additionally causes the foam element 20 to move toward the inner surface 62 of the tire 16, with the foam element 20 assuming a tight, complimentary engagement with the tire 16. In certain embodiments, the foam element 20 may conform to the shape of the tire 16. Furthermore, the inflation of the tube 18 may cause the foam element 20 to impart a force on the tire 16 which places the tire 16 in tension. Inflation further causes the tire beads 58, 60 to be captured within the lateral channels 42, 44 of the wheel rim 14, which essentially locks the tire 16 to the wheel rim 14, and allows the tire 16 and wheel rim 14 to rotate about the rotation axis 22 in concert with each other as a single unit.

When the tube 18 is inflated, the tube 18 preferably remains captured within the wheel rim channel 40 and the foam channel 84. In this respect, the tube 18 is preferably spaced from the tire 16, with such space being occupied by the foam element 20, thereby providing isolation to the tube 18 from punctures.

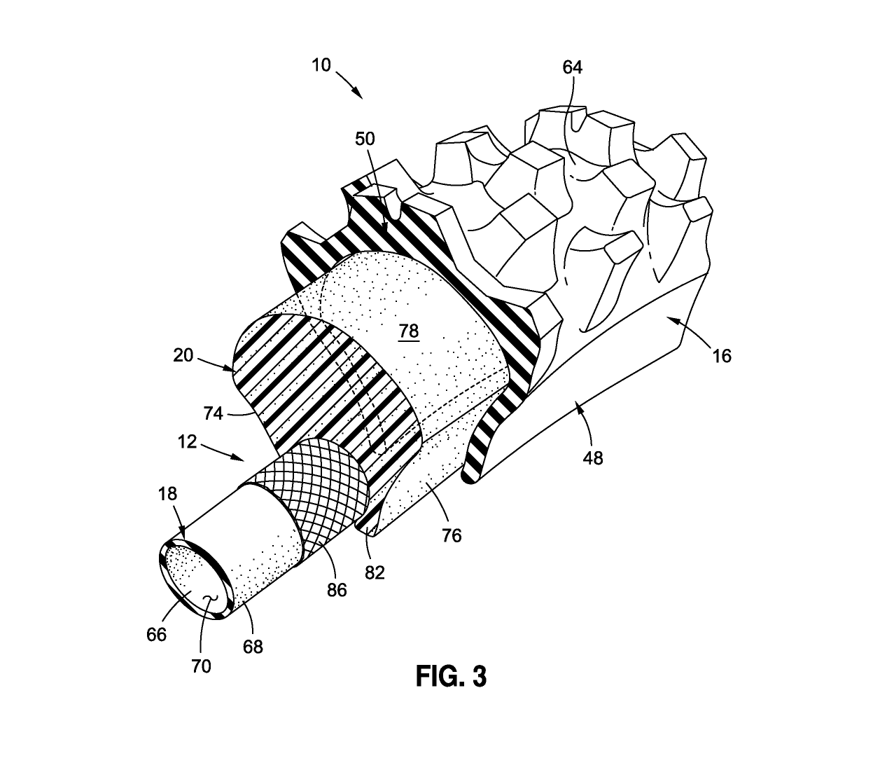

During use of the wheel 10, the foam element 20 may compress to support the load of the rider, as well as the motorcycle, bicycle, etc. FIG. 2 shows the foam element 20 and tire 16 in a compressed state, whereas FIG. 3 shows the foam element 20 and tire 16 in a neutral, or non-compressed state. As can be seen, in a non-compressed state, the end surface 78 of the foam element 20 may define a convex configuration (see FIG. 3), whereas in the compressed state, the end surface 78 may define a generally planar configuration (see FIG. 2). Furthermore, the side surfaces 74, 76 may define a slightly concave configuration when the foam element 20 is in the non-compressed state (see FIG. 3), whereas in the compressed state, the side surfaces 74, 76 may define a convex configuration (see FIG. 2).

If after repeated uses, the foam element 20 loses some of its resiliency, the user may inflate the tube 18 to a greater degree to compensate for the compression of the foam element 20. In this respect, the amount by which the user inflates the tube 18 may increase over time to offset any permanent compression of the foam element 20.

In the event the user decides to remove the insert 12 from the wheel 10, the insert 12 is deflated by deflating the tube 18. In this respect, the valve 72 is opened, which allows the pressurized fluid to be exhausted from the fluid chamber 70. The deflation of the tube 18 reduces the volume of the tube 18, thereby loosening the fit between the wheel rim 14, the insert 12, and the tire 16. At this point, it is easier to remove the insert 12 from the wheel 10.

It is to be appreciated that specific dimensions, proportions, shapes and configurations of each of the inflatable tube 18, foam element 20, and puncture resistance material 86 are not limited by the present disclosure. For example, the inflatable tube 18 as shown in FIG. 2 is of a cylindrical shape, but it may just as well be of any other suitable shape, such as oval, square, rectangular, triangular, etc.

Furthermore, although the foregoing describes the insert 10 as being particularly suited for use in off-road applications, e.g., for use with an off-road tire, it is contemplated that the present disclosure is not limited thereto. In this respect, various embodiments of the insert 10 may be particularly adapted for use in conventional road bicycles, motorcycles, or other on-road vehicles.

Additional modifications and improvements of the present invention may also be apparent to those of ordinary skill in the art. Thus, the particular combination of components and steps described and illustrated herein is intended to represent only certain embodiments of the present invention, and is not intended to serve as limitations of alternative devices and methods within the spirit and scope of the invention.

What is claimed is:

1. An inflatable insert for use with a tire and a wheel rim, the inflatable insert comprising:
an inflatable tube having an outer surface and an inner surface, the inflatable tube being configured to circumvent an outer diameter of the wheel rim, the inflatable tube being selectively transitional between an inflated configuration and a deflated configuration, wherein fluid is inserted into the inflatable tube to transition the inflatable tube from the deflated configuration toward the inflated configuration; and
a foam element cooperating with the inflatable tube and having an outer surface complimentary to an inner surface of the tire, the foam element being configured to substantially occupy a space between the outer surface of the inflatable tube and the inner surface of the tire when the inflatable insert is positioned between the tire and the wheel rim.

2. The inflatable insert of claim 1, wherein the inflatable tube is lined with a puncture resistant material.

3. The inflatable insert of claim 2, wherein the puncture resistant material is Kevlar material.

4. The inflatable insert of claim 2, wherein the puncture resistant material is positioned adjacent the outer surface of the inflatable tube.

5. The inflatable insert of claim 1, wherein a stiffness of the inflatable tube in the inflated configuration is greater than a stiffness of the foam element.

6. The inflatable insert of claim 1, wherein the foam element is lined with a polymer material to facilitate installation between the wheel rim and the tire.

7. The inflatable insert of claim 1, wherein the inner surface of the inflatable tube defines a fluid chamber, the inflatable insert further comprising:
a valve element coupled to the inflatable tube and in fluid communication with the fluid chamber.

8. The inflatable insert of claim 7, wherein the valve element comprises a tire pressure monitor sensor and display gauge.

9. The inflatable insert of claim 1, wherein a pressure within the inflatable tube increases as the inflatable tube is transitioned from the deflated configuration toward the inflated configuration.

10. The inflatable insert of claim 1, wherein a volume of the inflatable tube increases when the inflatable tube is transitioned from the deflated configuration toward the inflated configuration.

11. The inflatable insert of claim 1, wherein the foam element imparts a radially outward force upon the tire when the insert is positioned between the wheel rim and the tire, and when the inflatable tube is transitioned from the deflated configuration to the inflated configuration.

12. The inflatable insert recited in claim 1, wherein the foam element partially encapsulates the inflatable tube.

13. The inflatable insert recited in claim 1, wherein the foam element includes a convex surface extending between a pair of sidewalls.

14. The inflatable insert recited in claim 1, wherein the foam element includes a concave surface defining a cavity, the inflatable insert being at least partially received within the cavity.

15. An insert for use with a wheel rim and an off-road tire, the insert comprising:
a non-inflatable, compressible element having an outer surface that is of an external configuration complimentary to an inner surface of the off-road tire; and
an inflatable element cooperating with the non-inflatable, compressible element and configured to be selectively transitional between a deflated configuration and an inflated configuration, the volume of the inflatable element increasing as the inflatable element is transitioned from the deflated configuration toward the inflated configuration;
the non-inflatable, compressible element and the inflatable element being sized and configured to substantially occupy a space between the wheel rim and the off-road tire when the insert is placed between the wheel rim and the off-road tire, and the inflatable element is transitioned from the deflated configuration toward the inflated configuration.

16. The insert of claim 15, wherein the inflatable element is lined with a puncture resistant material.

17. The insert of claim 15, wherein an inner surface of the inflatable element defines a fluid chamber, the insert further comprising:
a valve element coupled to the inflatable element and in fluid communication with the fluid chamber.

18. The insert recited in claim 15, wherein the foam element partially encapsulates the inflatable tube.

19. The insert recited in claim 15, wherein the non-inflatable, compressible element includes a convex surface extending between a pair of sidewalls.

20. The insert recited in claim 15, wherein the non-inflatable, compressible element includes a concave surface defining a cavity, the inflatable element being at least partially received within the cavity.
